(19) United States
(12) Patent Application Publication
(10) Pub. No.: US 2006/0182899 A1
(43) Pub. Date: Aug. 17, 2006

(54) Polymer networks, methods of fabricating and devices

(76) Inventors: Stephen M. Kelly, Beverley (GB); Mary O'Neill, Hull (GB); Matthew P. Aldred, Hull (GB); Pano Vlachos, Hull (GB)

Correspondence Address: MCKEE, VOORHEES & SEASE, P.L.C., 801 GRAND AVENUE, SUITE 3200, DES MOINES, IA, 50309-2721, US

(21) Appl. No.: 11/403,477

(22) Filed: Apr. 13, 2006

Related U.S. Application Data
(62) Division of application No. 10/632,430, filed on Jul. 31, 2003.

(51) Int. Cl. C09K 19/00; G02F 1/03

(52) U.S. Cl. 428/1.3; 430/20

(57) ABSTRACT

A method of forming a layer including mixing at least a first material and a second material to form a mixture, depositing the mixture on a surface, and polymerizing the mixture to form a polymer network. The polymer network being at least one of charge-transporting or luminescent has improved properties as compared to the first and second materials including the rate of polymerization, the power level, time, and/or amount of energy per unit of mass used for polymerizing. The polymer network may be formed on an alignment layer that is unrubbed such as a photoalignment layer. The polymer network may be fabricated with uniform structure and thickness. The polymer network may have a liquid crystal phase and includes few dangling radicals and molecular fragments.

### CROSS-REFERENCE TO RELATED APPLICATIONS

This is a Divisional Application of U.S. Ser. No. 10/632,430 filed Jul. 31, 2003 which application is hereby incorporated by reference in its entirety.

### FIELD OF THE INVENTION

The present invention relates generally to polymer networks, methods of fabricating polymer networks and devices including polymer networks, and more particularly, to polymer networks formed from mixtures of reactive mesogens, methods of fabricating polymer networks formed from mixtures of reactive mesogens and devices including polymer networks formed from mixtures of reactive mesogens.

### BACKGROUND OF THE INVENTION

The performance of electronic and display devices is continually being increased to meet the needs of new applications and to improve current applications. Unfortunately, these performance increases are inhibited by the degradations that result during the fabrication processes and/or result because of the structural elements included in such devices. For example, crosslinking organic semiconductor material with UV light causes the formation of dangling radicals, molecular fragments and the like that negatively impact the performance of the organic semiconductor material and the device in which the material is included. Reducing the amount of UV light used to crosslink a material leaves the material only partially crosslinked. Since the unpolymerized (uncrosslinked) material is not incorporated into the crosslinked material matrix, the unpolymerized material may be washed away by solvents used in subsequent fabrication steps and this may result in the creation of voids. These voids are randomly formed and result in non-uniform films that negatively impact the performance of the film. Similar non-uniformity problems also occur due to the inclusion of certain structural elements such as rubbed alignment layers.

Accordingly, there is a strong need in the art for fabrication processes and devices that have reduced material degradation and non-uniformities due to the organic semiconductor material or layer.

### BRIEF SUMMARY OF THE INVENTION

An aspect of the present invention is to provide a method of forming a layer including mixing at least a first material and a second material to form a mixture, depositing the mixture on a surface and polymerizing the mixture to form a polymer network, the polymer network being at least one of charge-transporting or luminescent. The rate of polymerization of the mixture is greater than a rate of polymerization of the first material and the rate of polymerization of the mixture is greater than a rate of polymerization of the second material.

Another aspect of the invention is to provide a method of forming a layer including mixing at least a first material and a second material to form a mixture, depositing the mixture on a surface and polymerizing the mixture to form a polymer network, the polymer network being at least one of charge-transporting or luminescent. The amount of energy per unit of mass used for polymerizing the mixture is less than an amount of energy per unit of mass used for polymerizing of the first material and an amount of energy per unit of mass used for polymerizing of the mixture is less than an amount of energy per unit of mass used for polymerizing of the second material.

Another aspect of the invention is to provide a method of forming a layer including mixing at least a first material and a second material to form a mixture, depositing the mixture on a surface and polymerizing the mixture to form a polymer network, the polymer network being at least one of charge-transporting or luminescent. The power level used for polymerizing the mixture is less than a power level used for polymerizing of the first material and the power level used for polymerizing of the mixture is less than an a power level used for polymerizing of the second material.

Another aspect of the invention is to provide a method of forming a layer including mixing at least a first material and a second material to form a mixture, depositing the mixture on a surface and polymerizing the mixture to form a polymer network, the polymer network being at least one of charge-transporting or luminescent. The time used for polymerizing the mixture is less than a time used for polymerizing of the first material and the time used for polymerizing of the mixture is less than a time used for polymerizing of the second material.

Another aspect of the invention is to provide a method of forming a layer including mixing at least a first material and a second material to form a mixture, depositing the mixture on a surface and polymerizing the mixture to form a polymer network, the polymer network being at least one of charge-transporting or luminescent. The crosslink density of the mixture is greater than a crosslink density of the first material provided both the mixture and the first material are polymerized under the same conditions and the crosslink density of the mixture is greater than a crosslink density of the second material provided both the mixture and the second material are polymerized under the same conditions.

Another aspect of the invention is to provide a charge-transporting or luminescent layer including a mixture of at least a first and second material on an alignment layer that is unrubbed, the mixture being capable of forming a polymer network that is at least one of charge-transporting or luminescent.

Another aspect of the invention is to provide a charge-transporting or luminescent layer including a polymer network that is at least one of charge-transporting or luminescent. The polymer network is on an alignment layer that is unrubbed.

### BRIEF DESCRIPTION OF THE DRAWINGS

The invention will be described in detail with reference to the following drawings in which like reference numerals refer to like elements wherein:

FIG. 1 illustrates an organic light emitting device according to the present invention.

FIG. 2 illustrates an exemplary process of fabricating the device of including one or more mixtures of reactive mesogen material that is polymerized.

FIG. 3 shows the absorption spectra of a mixture before and after crosslinking (graph line a), after washing (graph line b), and shows the PL spectrum of an insoluble liquid crystalline polymer network formed as a thin solid film after crosslinking of the mixture (graph line c).

### DETAILED DESCRIPTION OF THE PREFERRED EMBODIMENT

Organic material that is able to be aligned on a molecular basis may be deposited on a substrate or other surface and then crosslinked to form a crosslinked polymer network. By using a mixture of polymerizable (crosslinkable) materials instead of a single polymerizable material, the rate of polymerisation may be increased. This increased polymerization rate facilitates room temperature fabrication in much shorter times and with much less energy being applied. This decrease in the energy being applied into the organic material decreases the amount of degradation produced by the polymerization process. Additionally, the use of a mixture may also improve the crosslinking density, may improve the quality or uniformity of alignment, and may improve the uniformity of the crosslinked polymer network.

For example, solvent solutions of binary or other mixtures of charge-transporting and/or light-emitting reactive mesogens with liquid crystalline phases (e.g., nematic or smectic phases) may be spin coated on a conducting photoalignment layer. The spin coating may be done at room temperature to form a film of liquid crystal either in a liquid crystalline phase that is thermodynamically stable at room temperature or in a super cooled liquid crystalline phase below its normal solid to liquid crystal phase transition temperature. Mixtures with thermodynamically stable liquid crystalline phases at room temperature have the advantage of lower viscosity and subsequent ease of crosslinking polymerization. The photoalignment layer aligns the reactive mesogen mixtures at room temperature on the substrate surface with the liquid crystalline director in the plane of the substrate such that one or more monodomains with planar orientation is formed. The charge injection and transport in the crosslinked polymer network is facilitated by the planar orientation. The presence of many different domains does not impair the charge injection and transport of the layers or the emission properties of devices containing such layers. The photoalignment layer may be irradiated by plane polarized UV light to create uniformly anisotropic surface energy at the layer surface. When the reactive mesogen mixture is subsequently coated on the photoalignment layer, the mixture and subsequent polymer network produced on crosslinking have a macroscopic monodomain. Additionally, the polymer network is insoluble and intractable which allows further layers with a different function to be deposited subsequently in a similar fashion.

The photoalignment layer may be used to align a layer of a mixture of reactive mesogens that becomes a polymeric hole transport layer with liquid crystalline order capon subsequent solvent casting on the photoalignment layer and crosslinking by exposure to UV radiation. Then a second layer of a mixture of reactive mesogens may be solvent cast on top of the hole transport layer. This second layer is aligned into a liquid crystalline monodomain by interaction with the aligned surface of the hole transport layer. The alignment of the second layer is believed to be achieved by molecular interactions between the molecules of the reactive mesogen materials at the interface between the two layers. The second reactive mesogen monolayer may now be crosslinked by exposure to UV radiation to form a polymeric emitter layer. Thus a series of organic semiconductor layers with liquid crystalline order may be built up with all of the molecular cores of the polymers oriented in the same direction.

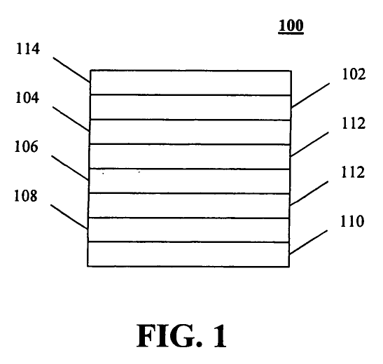

For example, FIG. 1 illustrates an organic light emitting device 100 according to the present invention that includes a hole injection layer 102, hole transport layer 104, an emitter 106, an electron transport layer 108, an electron injection layer 110, and charge carrier blocker layers 112 may be produced one layer at a time with all of the layers having mutually aligned liquid crystalline order. The device may be fabricated on a suitable alignment layer 114 and may include substrates and other elements not shown. Alternatively, some of these layers (including the alignment layer) may be omitted, a subset of adjacent layers may be built up according to this method, or subset of adjacent layers may be built up according to this method with some of the layers (including the alignment layer) being omitted.

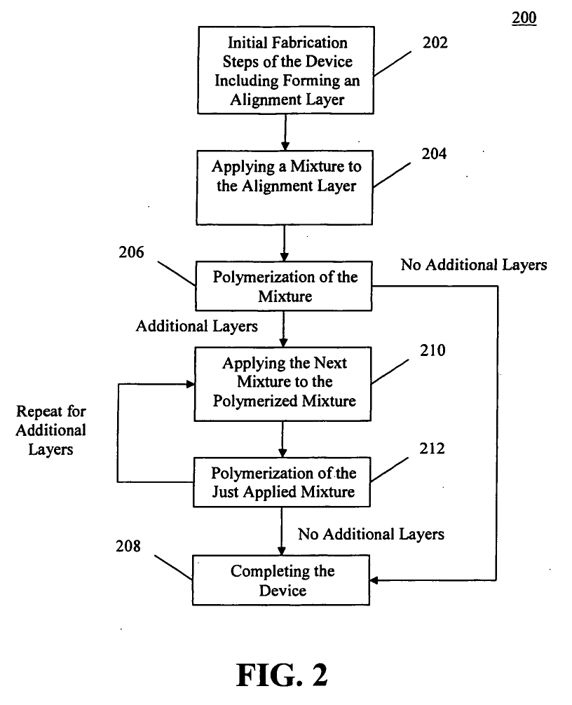

FIG. 2 illustrates an exemplary process 200 of fabricating the device including one or more mixtures of reactive mesogen material that is polymerized. The process, 200 begins with the initial fabrication steps of the device including forming an alignment layer 202. The next step 204 is applying a mixture to the alignment layer followed by the polymerization of the mixture step 206. If there are no additional layers to be formed from a mixture, the final step 208 of completing the device is performed. If there are additional layers, the next step 210 of applying the next mixture to the polymerized mixture is performed followed by the polymerization of the just applied mixture step 210. If there are no additional layers to be formed from a mixture, the final step 208 of completing the device is performed. If there are additional layers, the last two steps 210, 212 are repeated.

If the polymerization process does not need an initiator, such as a photoinitiator, there will be no unreacted initiators to quench emission or degrade the performance and lifetime. For example, ionic photoinitiators may act as impurities in finished electronic devices and degrade the performance and lifetime of the devices.

Any suitable conducting photoalignment layer may be used. For example, the photoalignment layers described in US 2003/0021913 may be used. Alternatively, alignment may be achieved by any other suitable alignment layer or may be achieved without an alignment layer (e.g., the application of electric or magnetic fields, the application of thermal gradients or shear, surface topology, another suitable alignment technique or the combination of two or more techniques). However, rubbed alignment layers are not suitable for organic semiconductor layers and elements, such as the emitter layer in an organic light emitting device or semiconductor layers in integrated circuitry, because the organic layers and elements in such devices are thinner than the amplitude of the surface striations produced in alignment layers by rubbing. In some cases, the roughness resulting from the rubbing process has a thickness on the order of the thickness of the organic layers and elements. Additionally, diverse alignments may be imparted by an alignment layer(s) or technique(s). These diverse alignments may be in a pattern suitable for use in a pixelated device.

The crosslinking density of a network formed from a mixture of polymerizable monomers is higher than that of a network formed by the polymerization of the corresponding individual monomers. The increased crosslinking density may result because in formulating a mixture the solid to liquid crystal transition temperature is depressed below that of any of the individual components and may be depressed below room temperature. This means that the mixture has a thermodynamically stable liquid crystalline phase at room temperature and, as a result, has considerably reduced viscosity as compared to the super cooled glassy liquid crystalline phases of the individual components. This in turn means that reactive mesogen molecules are more mobile within the room temperature phase and thus are able to more quickly and more easily orient themselves to initiate the crosslinking reactions. Such anisotropic polymer network having a higher crosslinking density improves the performance of devices including layers, films or elements fabricated from the network and results in more stable devices.

### EXAMPLE 1

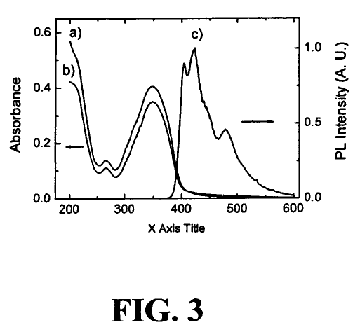

A binary mixture of 2,7-bis{4-[7-(1-vinylallyloxycarbonyl)heptyloxy]-4′-biphenyl}-9,9-dioctylfluorene mixed with 2,7-bis {4-[10-(1-vinylallyloxycarbonyl)decyloxy]-4′-biphenyl}-9,9-dioctylfluorene in a ratio of 1:3 (the mixture (mixture 1) has a low melting point (Cr—N=22° C.) and a high nematic clearing point (N—I=75° C.)) is coated on a quartz substrate and irradiated with unpolarised UV radiation from an argon ion laser. The laser emits 325 nm UV light and has a total fluence of 15 J cm⁻². The UV radiation causes photo polymerization of the diene end-groups without the use of a photoinitiator. The polymerization of the mixture is performed at room temperature (e.g., 25° C.) and users an order of magnitude less radiation (e.g., 200 J cm⁻²) than is needed to polymerize the mixture component 2,7-bis {4-[10-(1-vinylallyloxycarbonyl)decyloxy]-4′-biphenyl}-9,9-dioctylfluorene in the glassy nematic state at the same temperature. FIG. 3 shows the absorption spectra of the mixture after crosslinking is substantially the same as before crosslinking (graph line a) and improves after washing (graph line b). FIG. 3 shows the PL spectrum of the insoluble liquid crystalline polymer network formed as a thin solid film after crosslinking of mixture (graph line c).

### EXAMPLE 2

A binary mixture of compound I, 2-(5-{4-[10-(1-vinyl-allyloxycarbonyl)-decyloxy]phenyl}thien-2-yl)-7-{4-[10-(1-vinyl-allyloxycarbonyl)decyloxy]-4′-biphenyl}-9,9-dipropylfluorene (1 part) and of compound II, 2-(5-{4-[10-(1-vinyl-allyloxycarbonyl)-decyloxy]phenyl}thien-2-yl)-7-{4-[10-(1-vinyl-allyloxycarbonyl)decyloxy]-4′-biphenyl}-9,9-dioctylfluorene (1 part) is a room temperature nematic liquid crystal mixture (mixture 2). This material may also be coated on to a quartz substrate and crosslinked with radiation from an argon ion laser as above. After crosslinking, the insoluble liquid crystalline polymer network has blue photoluminescence.

Mixture 2 has good hole transporting characteristics and may be used as a hole transporting layer in an organic light emitting device. For example, a 50 nm thick layer of mixture 2 may be cast by spin coating from chloroform on an ITO-coated glass substrate previously coated with a conductive photoalignment layer such as described in US Patent Application 2003/0099785. The room temperature nematic is homogenously aligned into a uniform layer by the photoalignment layer. Unpolarized irradiation by an argon ion laser at 325 nm with a total fluence of 15 J cm⁻² may be used to crosslink the material. The irradiation may be carried out through a photomask if it is desired to pattern the hole transport layer. After exposure the layer may be washed with chloroform to remove uncrosslinked monomer.

Next a 50 nm layer of mixture 1 may be cast by spin coating from chloroform solution on top of the already fabricated hole transport layer fabricated from mixture 2. The room temperature nematic material of mixture 2 is homogenously aligned by intermolecular interactions at its interface with the hole transport layer. The nematic mixture 2 layer is irradiated with unpolarised 325 nm. UV radiation from an argon ion laser with a total fluence of 15 J cm⁻². This irradiation may also be carried out through a photomask to form a patterned emitter layer. As was described in US Patent Application 2003/0119936, the resulting multilayer assembly may be further assembled into a working organic light emitting device by vapor deposition of aluminum electrodes and hermetic packaging of the device.

The synthesis of the materials in mixture 1 is described in US Patent Application 2003/0119936, which is incorporated herein in its entirety by reference. Similar synthetic methods to those used in US Patent Application 2003/0119936 may be used to prepare compounds I and Il. The synthetic route used may be as follows: 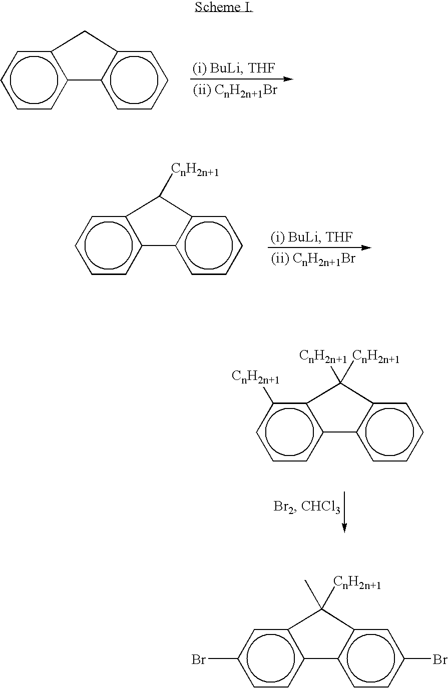 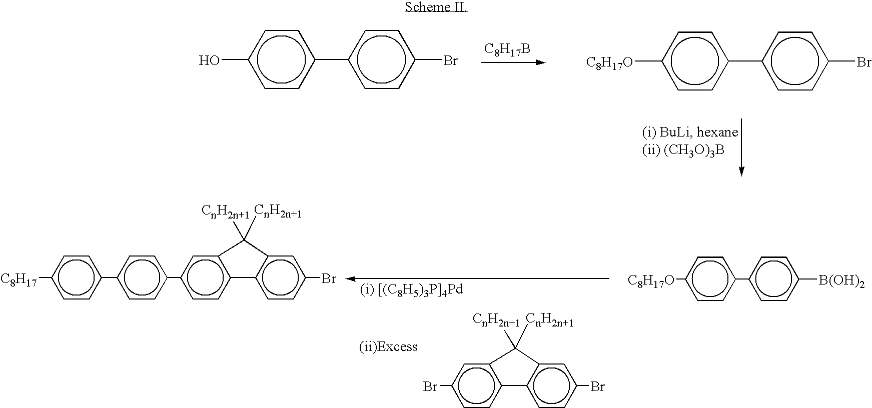 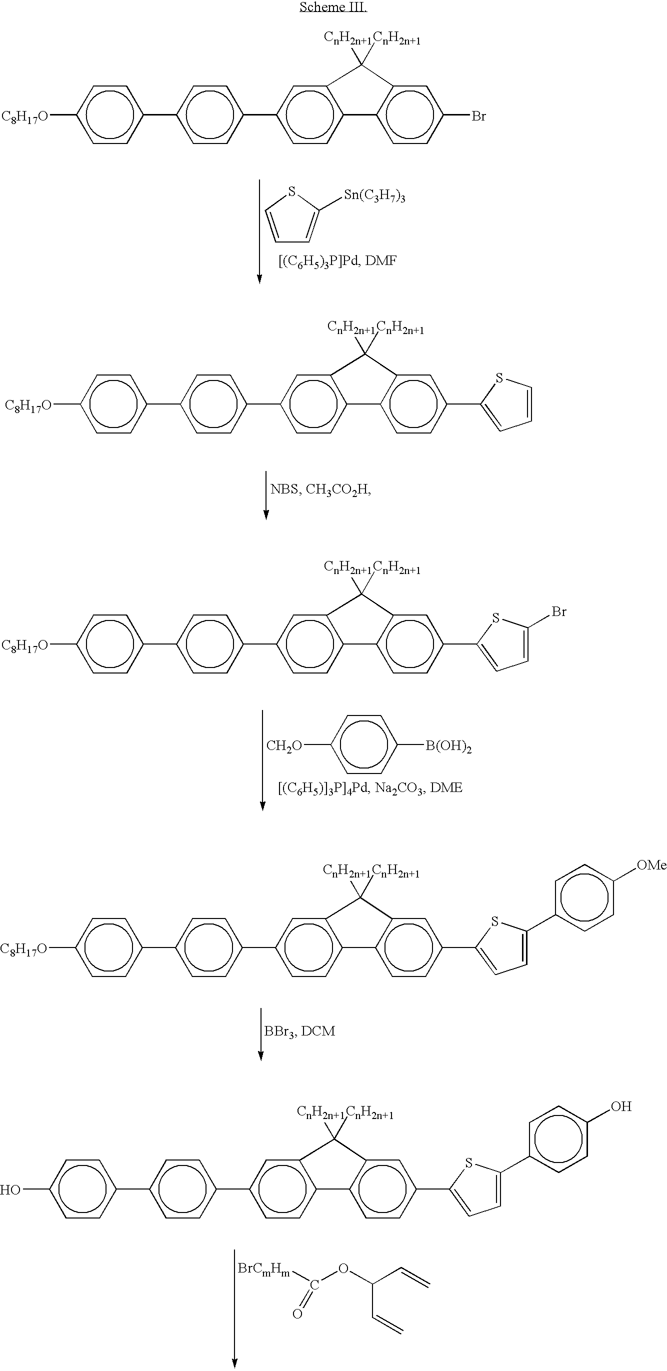 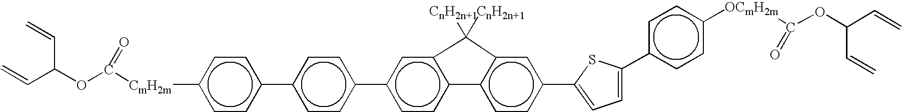
where n=3, m=10 for compound I and n=8, m 10 for compound II.

The materials of the mixture that are polymerized to form the polymer network may be made from any suitable material. For example, such materials include those suitable reactive mesogens having the general structure B-S-A-S-B wherein A is a chromophore, an aromatic molecular core, a heteroaromatic molecular core, or a rigid molecular core with conjugated pi-electron bonds, S is a spacer and B is an endgroup susceptible to radical polymerisation. Exemplary endgroups B include photopolymerisable non-conjugated diene groups such as a 1,4-pentadien-3-yl group, a 1,6-heptadien-4-yl group or a diallylamino group.

### EXAMPLE 3

Another exemplary embodiment is a stereoscopic display device fabricated as in Example 2 except the photoalignment layer includes a portion having a first alignment direction and a second alignment direction that is orthogonal to the first alignment direction. This results in an emitter layer that produces light of two different polarizations. If a viewer is wearing a pair of goggles or glasses with one eye viewing light of one polarization and the other eye viewing light of the orthogonal polarization, the viewer will be able to see a stereoscopic image. The goggles or glasses or other suitable eyewear may include simple polarizing lenses if the differently polarized areas of the display device are separately actuated or otherwise caused to separately emit light to the viewer (e.g., individual pixels corresponding to the differently aligned portions). Otherwise, the goggles or glasses or other suitable eyewear may include shutters, such as liquid crystal display shutters, that provided a time multiplexed image to the viewer so as to allow the differently aligned portions of a pixel to be actuated together. Alternatively, other suitable stereoscopic configurations may be used.

The mixtures of the present invention may be incorporated as anisotropic polymer networks in organic light-emitting devices. The polymer networks may be formed by polymerising mixtures of charge-transporting and/or light-emitting reactive mesogens. Such devices also may include a conducting photoalignment layer and when used in displays may be addressed with active or passive matrix addressing. The display devices may be monochrome or multicolor, and may be pixelated or unpixelated. The devices may have polarized emissions produced by emissive layers comprising the anisotropic polymer networks. The polarized light emitting devices may be used as monochrome or multicolor backlights (e.g., liquid crystal display backlights). Such organic light-emitting devices may incorporate anisotropic polymer networks as emissive layer or elements and may include luminescent dyes (e.g., pleochroic dyes). These polymer networks also may be security devices or stereoscopic displays.

The processes and devices disclosed herein are suitable for application to electronic devices, semiconductor devices, organic light emitting devices, and other devices. Exemplary applications include transistors such as FETs, transistor arrays such as those useful for addressing matrix displays, integrated electronic circuitry, mobile telephones, digital cameras, hand held computers, watches, clocks, game machines, and other consumer electronic goods.

Although several embodiments of the present invention and its advantages have been described in detail, it should be understood that changes, substitutions, transformations, modifications, variations, permutations and alterations may be made therein without departing from the teachings of the present invention, the spirit and the scope of the invention being set forth by the appended claims.

What is claimed is:

1. A charge-transporting or luminescent layer comprising:
a mixture of at least a first and second material on an alignment layer that is unrubbed, the mixture being capable of forming a polymer network that is at least one of charge-transporting or luminescent.

2. The layer of claim 1, wherein alignment layer is a photo-alignment layer.

3. The layer of claim 1, wherein the mixture has a polymerization rate greater than a polymerization rate of the first material; and wherein the mixture has a polymerization rate greater than a polymerization rate of the second material.

4. The layer of claim 1, wherein an amount of energy per unit of mass to polymerize the mixture is less than an amount of energy per unit of mass to polymerize the first material; and wherein the amount of energy per unit of mass to polymerize the mixture is less than an amount of energy per unit of mass to polymerize the second material.

5. The layer of claim 1, wherein a power level to polymerize the mixture is less than a power level to polymerize the first material; and wherein the power level to polymerize the mixture is less than an a power level to polymerize the second material.

6. The layer of claim 1, wherein a time to polymerize the mixture is less than a time to polymerize the first material; and wherein the time to polymerize of the mixture is less than a time to polymerize the second material.

7. The layer of claim 1, wherein the mixture is photo-polymerizable.

8. The layer of claim 1, wherein the mixture has a liquid crystal phase.

9. The method of claim 1, wherein the mixture has a liquid crystal phase that is thermodynamically stable at room temperature.

10. The method of claim 1, wherein at least one of the first material and the second material has the formula B-S-A-S-B, wherein A is at least one of a chromophore, an aromatic molecular core, a heteroaromatic molecular core, or a rigid molecular core with conjugated pi-electron bonds, S is a spacer, and B is an endgroup which is susceptible to photo polymerization.

11. The layer of claim 1, mixture has a uniform thickness.

12. The layer of claim 1, wherein the polymer network is included in one of a semiconductor device, a display device, and a thin film transistor device.

13. A charge-transporting or luminescent layer comprising:
a polymer network that is at least one of charge-transporting or luminescent, wherein the polymer network is on an alignment layer that is unrubbed.

14. The layer of claim 13, wherein alignment layer is a photo-alignment layer.

15. The layer of claim 13, wherein the polymer network has a liquid crystalline structure.

16. The layer of claim 13, wherein the polymer network includes at least one repeat unit having the formula B-S-A-S-B, wherein A is at least one of a chromophore, an aromatic molecular core, a heteroaromatic molecular core, or a rigid molecular core with conjugated pi-electron bonds, S is a spacer, and B is an endgroup which is susceptible to photo polymerization.

17. The layer of claim 13, the polymer network has a uniform structure.

18. The layer of claim 13, wherein the polymer network has a uniform thickness.

19. The layer of claim 18, wherein the polymer network has few dangling radical and molecular fragments.

20. The layer of claim 13, wherein the polymer network is included in one of a semiconductor device, a display device, and a thin film transistor device.
